(19) United States
(12) Patent Application Publication
(10) Pub. No.: US 2025/0222974 A1
(43) Pub. Date: Jul. 10, 2025

(54) STEERING APPARATUS FOR VEHICLE

(71) Applicant: HYUNDAI MOBIS CO., LTD., Seoul (KR)

(72) Inventors: Bong Soo KIM, Yongin-si (KR); Jeong Yeop KIM, Yongin-si (KR)

(73) Assignee: HYUNDAI MOBIS CO., LTD., Seoul (KR)

(21) Appl. No.: 18/949,658

(22) Filed: Nov. 15, 2024

(30) Foreign Application Priority Data
Jan. 5, 2024 (KR) 10-2024-0002145
Oct. 11, 2024 (KR) 10-2024-0138548

(51) Int. Cl. B62D 5/00

(52) U.S. Cl. CPC B62D 5/006

(57) ABSTRACT

A steering apparatus for a vehicle according to the present disclosure includes a housing, an input shaft part rotatably mounted in the housing, a conversion guide part mounted on the input shaft part and configured to guide the input shaft part so that the input shaft part rectilinearly moves in the housing, and a reaction force part configured to adjust a steering reaction force of the input shaft part while providing an elastic force to the input shaft part.

### CROSS-REFERENCE TO RELATED APPLICATIONS

This application claims priority from and the benefit under 35 U.S.C. § 119 of Korean Patent Application No. 10-2024-0002145, filed on Jan. 5, 2024, and Korean Patent Application No. 10-2024-0138548, filed on Oct. 11, 2024, in the Korean Intellectual Property Office, the entire disclosure of which is incorporated by reference for all purposes.

### TECHNICAL FIELD

Exemplary embodiments of the present disclosure relate to a steering apparatus for a vehicle, and more particularly, to a steering apparatus for a vehicle, which is capable of allowing a driver to steer a vehicle while feeling a steering reaction force.

### BACKGROUND

A steer-by-wire (SBW) system refers to a steering apparatus that is operated by a driver in response to an electrical signal without mechanical connection between a column, which is connected to a steering wheel, and an actuator configured to steer a vehicle wheel.

A steering feedback actuator (SFA) refers to a device configured to provide the driver with a reaction force through the steering wheel by changing torque for each vehicle speed by using a motor and a speed reducer.

Because a steering reaction force, which is generated by fluctuation of straightness of the vehicle, which is transmitted from tires, and toe angles during the steering process, cannot be transmitted to the driver when the SBW is applied, the SFA needs to arbitrarily control the motor to make the steering wheel light under a low-speed condition and make the steering wheel heavy under a high-speed condition.

To this end, a structure of a reaction force actuator including the motor and the speed reducer needs to be provided. However, because of the reaction force actuator, there is a problem in that manufacturing costs and weight of the steering apparatus are increased. Accordingly, there is a need to solve the problem.

### SUMMARY

A reaction force part configured to adjust a steering reaction force of the input shaft part while providing an elastic force to the input shaft part. Various embodiments are directed to a steering apparatus for a vehicle, which is capable of allowing a driver to steer a vehicle while feeling a steering reaction force.

In an embodiment, a steering apparatus for a vehicle according to the present disclosure includes a housing, an input shaft part rotatably mounted in the housing, a conversion guide part mounted on the input shaft part and configured to guide the input shaft part so that the input shaft part rectilinearly moves in the housing, and a reaction force part configured to adjust a steering reaction force of the input shaft part while providing an elastic force to the input shaft part.

The reaction force part may include: a motor part; a screw nut part connected to a motor shaft part of the motor part and configured to be moved by a rotation of the motor shaft part; and an elastic part interposed between the screw nut part and the input shaft part and configured to be elastically deformed by the movements of the screw nut part and the input shaft part.

The screw nut part may include: a screw nut body part screw-fastened to the motor shaft part and configured to move in accordance with a rotation of the motor shaft part; a screw nut pressing part configured to press the elastic part while moving in accordance with a movement of the screw nut body part; and a screw nut interposition portion mounted on the motor shaft part and disposed between the screw nut body part and the screw nut pressing part.

The screw nut body part may include: a screw nut body movement portion screw-fastened to the motor shaft part; and a screw nut rotation restriction portion protruding externally of the screw nut body movement portion and configured to adjoin an inner side of the housing to restrict a rotation of the screw nut body movement portion.

The screw nut pressing part may include: a hollow screw nut pressing movement portion having a central portion into which the motor shaft part is inserted; and a screw nut pressing rotation restriction portion protruding externally of the screw nut pressing movement portion and configured to adjoin the inner side of the housing to restrict a rotation of the screw nut pressing movement portion.

The screw nut pressing rotation restriction portion may be moved toward the elastic part by being pressed by the screw nut rotation restriction portion.

The screw nut pressing part may further include a screw nut crest/trough portion having a crest and a trough formed on one surface of the screw nut pressing movement portion opposite to the screw nut interposition portion.

The screw nut interposition portion may include: a screw nut interposition body portion mounted on the motor shaft part and interposed between the screw nut body part and the screw nut pressing part; and a screw nut interposition protrusion portion protruding from the screw nut interposition body portion and configured to be rotatable in a state in which the screw nut interposition protrusion portion adjoins the screw nut crest/trough portion.

The screw nut interposition portion may be provided as a plurality of screw nut interposition portions protruding from the screw nut interposition body portion toward the input shaft part and further include a screw nut interposition fastening portion fastened to the input shaft part.

The conversion guide part may include: a first conversion guide part configured to adjoin the clastic part and be provided with an elastic force from the clastic part; a second conversion guide part disposed to be spaced apart from the first conversion guide part and configured to allow the input shaft part to be rotatably mounted on the second conversion guide part; and a rotation restriction part configured to connect the first conversion guide part and the second conversion guide part and restrict a rotation angle of the input shaft part.

The conversion guide part may further include conversion protruding portions respectively protruding from the first conversion guide part and the second conversion guide part and inserted into an inner surface of the housing.

The input shaft part may include: an input shaft rotatably mounted on the second conversion guide part; and an input protrusion portion protruding from an outer surface of the input shaft and configured to be movable between the first conversion guide part and the second conversion guide part, the input protrusion portion being configured to be caught by the rotation restriction part so that a movement of the input protrusion portion is restricted.

The input shaft part may further include an input fastening part mounted at an end of the input shaft and fastened to the screw nut interposition fastening portion.

The input fastening part may include: an input fastening base portion disposed to be spaced apart from the input protrusion portion; a plurality of input fastening coupling portions protruding from a first side of the input fastening base portion and fastened to the screw nut interposition fastening portion; and an input fastening clastic portion interposed between the input fastening base portion and the input protrusion portion and configured to be elastically deformable.

The input fastening part may further include an input fastening fixing portion protruding from a second side of the input fastening base portion and configured to be selectively coupled to the input protrusion portion while moving.

The steering apparatus may further include: a sensor part configured to measure a rotation angle of the input shaft part.

The sensor part may be configured as a torque and angle sensor (TAS) configured to measure the amount of torque of the input shaft and measure a rotation angle of the input protrusion portion.

The sensor part may be configured as a linear sensor configured to measure a position of the input protrusion portion.

According to the steering apparatus for a vehicle according to the present disclosure, the driver may steer the vehicle while sufficiently feeling the steering reaction force by means of the compressive elastic force of the elastic part even without a speed reducer.

In addition, according to the present disclosure, it is possible to control the reaction force by adjusting the compression length of the elastic part in accordance with the velocity of the vehicle by using the small-scale motor part and the screw nut part.

In addition, according to the present disclosure, it is not necessary to use a basic speed reducer and a large motor, and the constituent components may be simplified by the clastic part and the small-scale motor part, such that manufacturing costs may be reduced, and the productivity may be improved.

### BRIEF DESCRIPTION OF THE DRAWINGS

FIG. 1 is a perspective view schematically illustrating an entire steering apparatus for a vehicle according to an embodiment of the present disclosure.

FIG. 2 is a perspective view schematically illustrating the steering apparatus for a vehicle according to the embodiment of the present disclosure.

FIG. 3 is a perspective view schematically illustrating a main configuration of the steering apparatus for a vehicle according to the embodiment of the present disclosure when viewed in one direction.

FIG. 4 is an assembled perspective view schematically illustrating the steering apparatus for a vehicle according to the embodiment of the present disclosure.

FIG. 5 is a front view schematically illustrating the main configuration of the steering apparatus for a vehicle according to the embodiment of the present disclosure.

FIG. 6 is a perspective view schematically illustrating the main configuration of the steering apparatus for a vehicle according to the embodiment of the present disclosure when viewed in the other direction.

FIG. 7 is a perspective view schematically illustrating a normal operation mode of the vehicle in the main configuration of the steering apparatus for a vehicle according to the embodiment of the present disclosure.

FIG. 8 is a front view schematically illustrating the normal operation mode of the vehicle in the main configuration of the steering apparatus for a vehicle according to the embodiment of the present disclosure.

FIG. 9 is a perspective view schematically illustrating a low-speed operation mode of the vehicle in the main configuration of the steering apparatus for a vehicle according to the embodiment of the present disclosure.

FIG. 10 is a front view schematically illustrating the low-speed operation mode of the vehicle in the main configuration of the steering apparatus for a vehicle according to the embodiment of the present disclosure.

FIG. 11 is a perspective view schematically illustrating a high-speed operation mode of the vehicle in the main configuration of the steering apparatus for a vehicle according to the embodiment of the present disclosure.

FIG. 12 is a front view schematically illustrating the high-speed operation mode of the vehicle in the main configuration of the steering apparatus for a vehicle according to the embodiment of the present disclosure.

FIG. 13 is a perspective view schematically illustrating an input shaft part of the steering apparatus for a vehicle according to the embodiment of the present disclosure.

FIG. 14 is an assembled perspective view schematically illustrating the input shaft part of the steering apparatus for a vehicle according to the embodiment of the present disclosure.

FIG. 15 is an assembled front view schematically illustrating the input shaft part of the steering apparatus for a vehicle according to the embodiment of the present disclosure.

FIG. 16 is an exploded front view schematically illustrating the input shaft part of the steering apparatus for a vehicle according to the embodiment of the present disclosure.

### DETAILED DESCRIPTION

Hereinafter, a steering apparatus for a vehicle will be described below with reference to the accompanying drawings through various exemplary embodiments. Here, thicknesses of lines, sizes of constituent elements, or the like illustrated in the drawings, may be exaggerated for clarity and convenience of description.

In addition, the terms used below are defined in consideration of the functions thereof in the present disclosure and may vary depending on the intention of a user or an operator or a usual practice. Therefore, such terms should be defined based on the entire contents of the present specification.

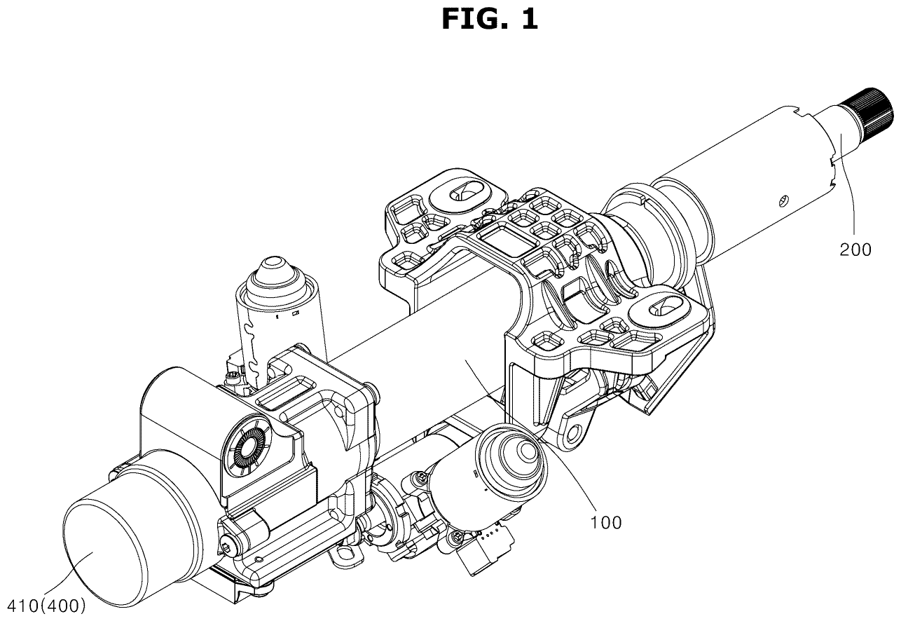

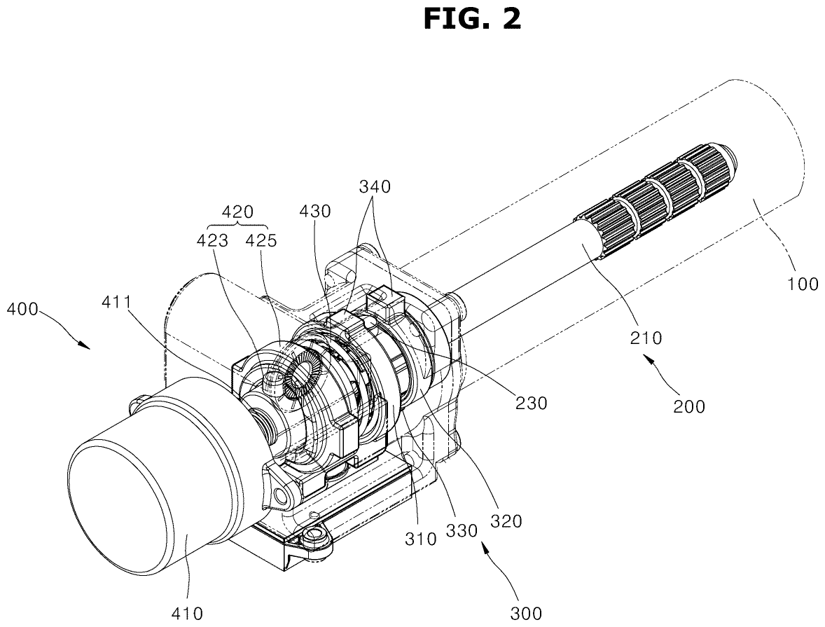

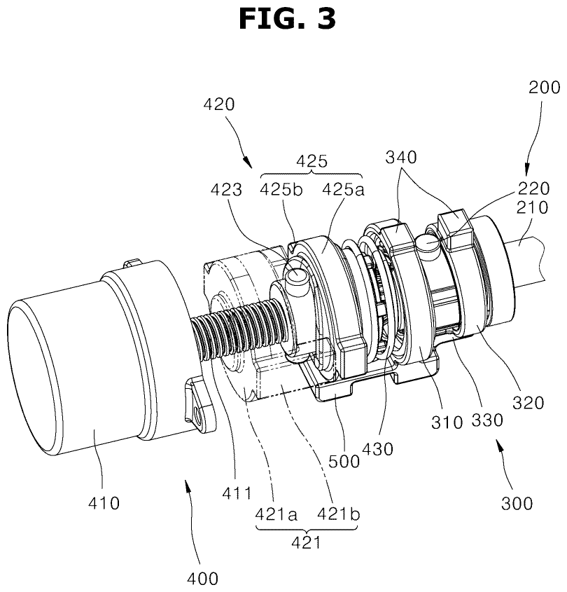

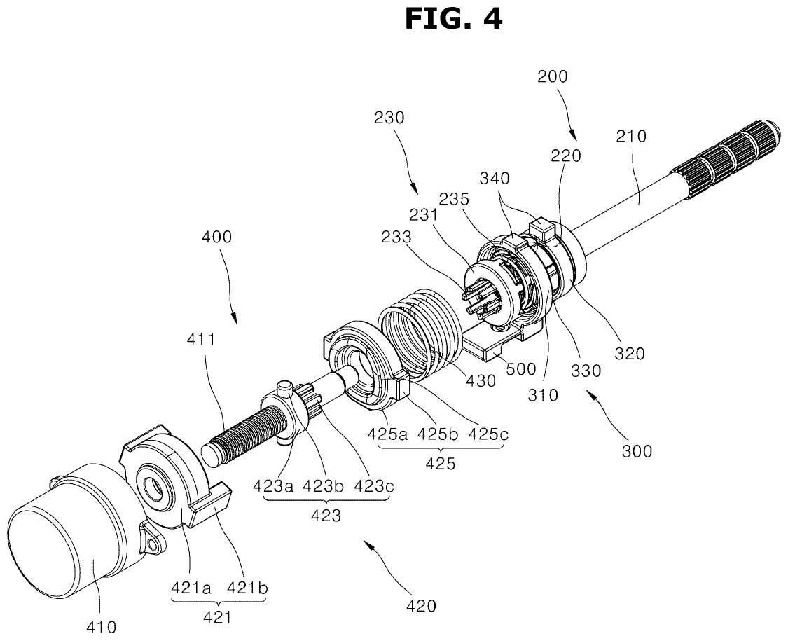

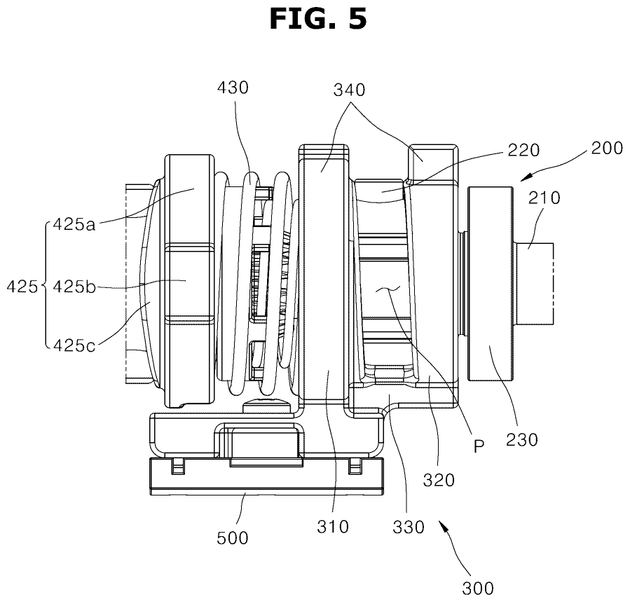

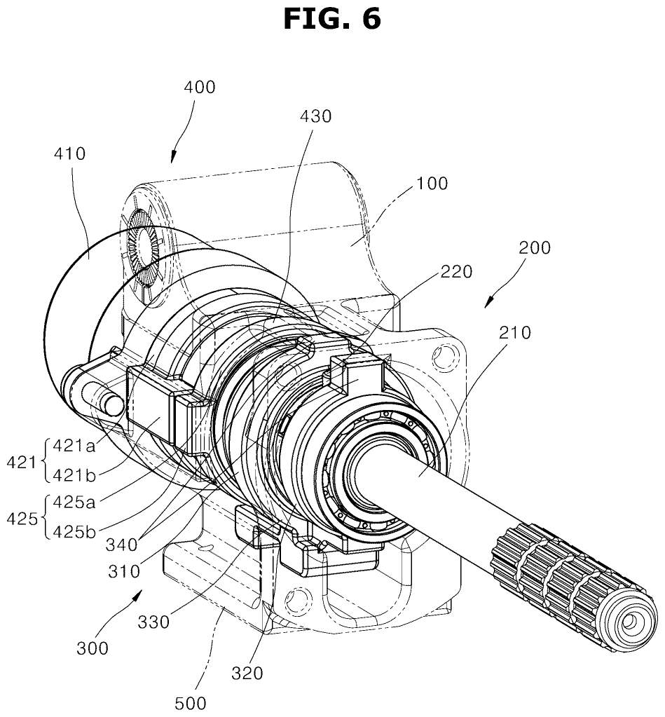

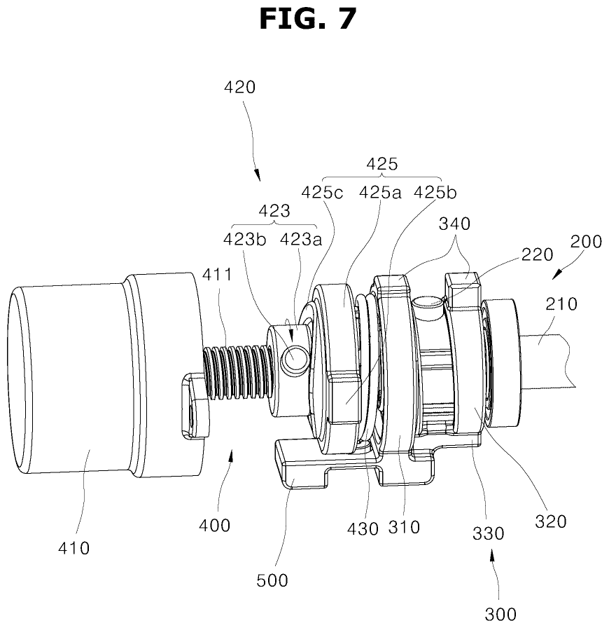

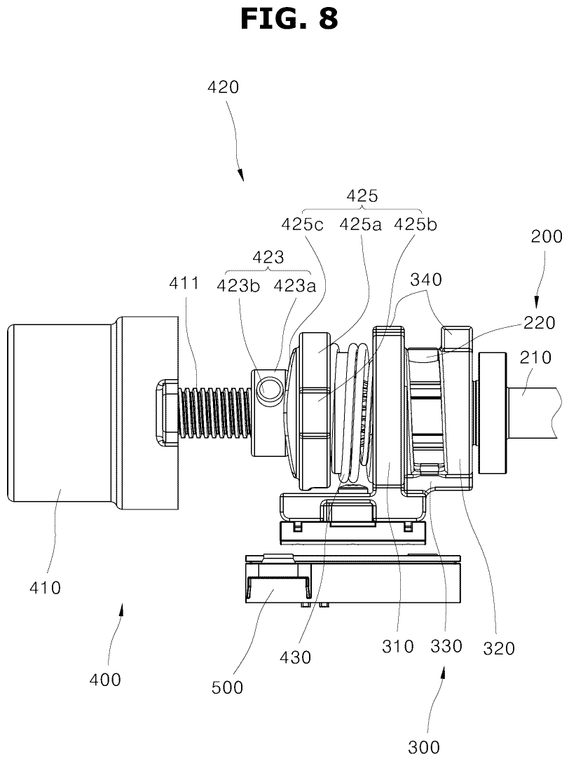

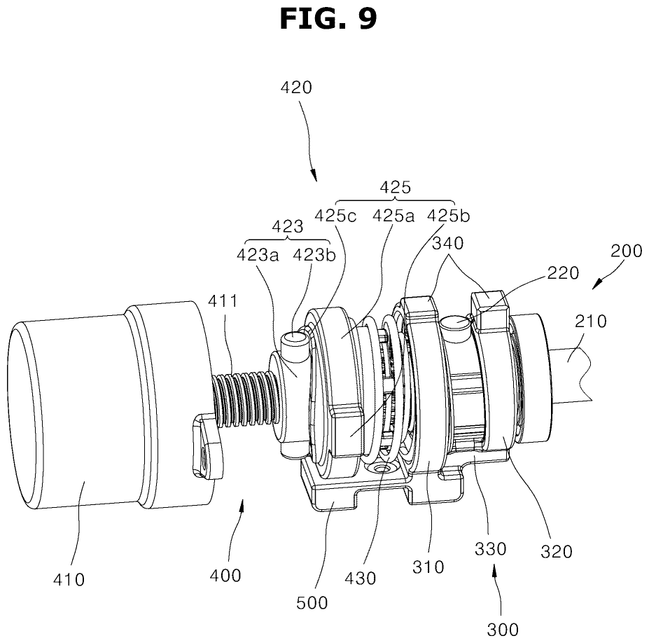

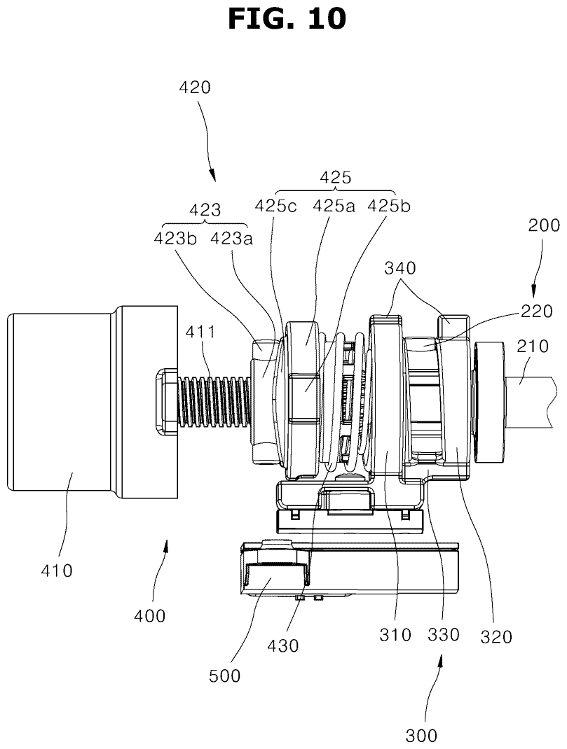

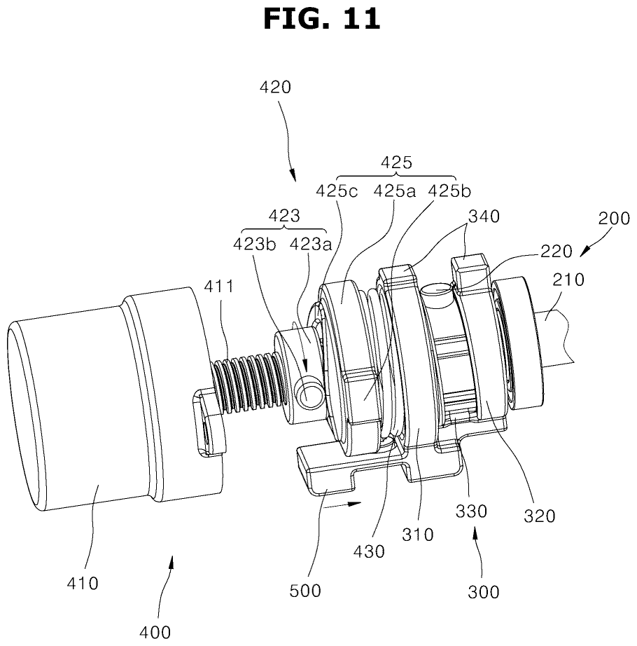

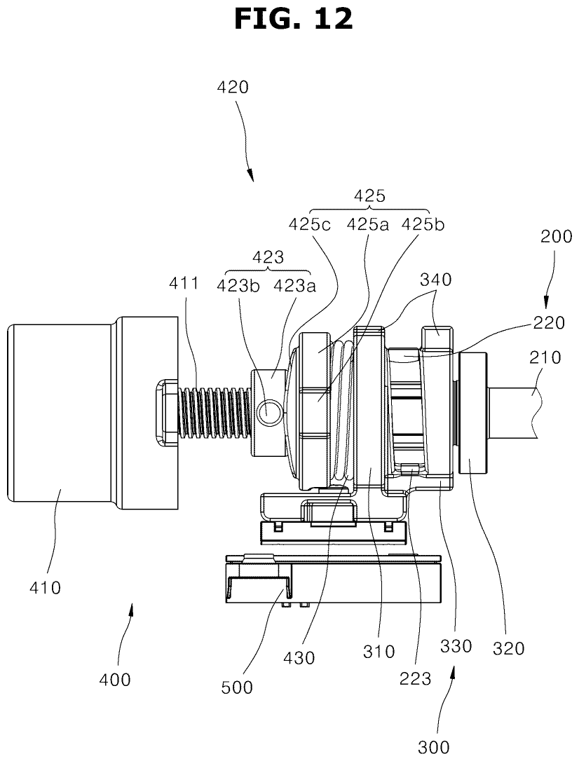

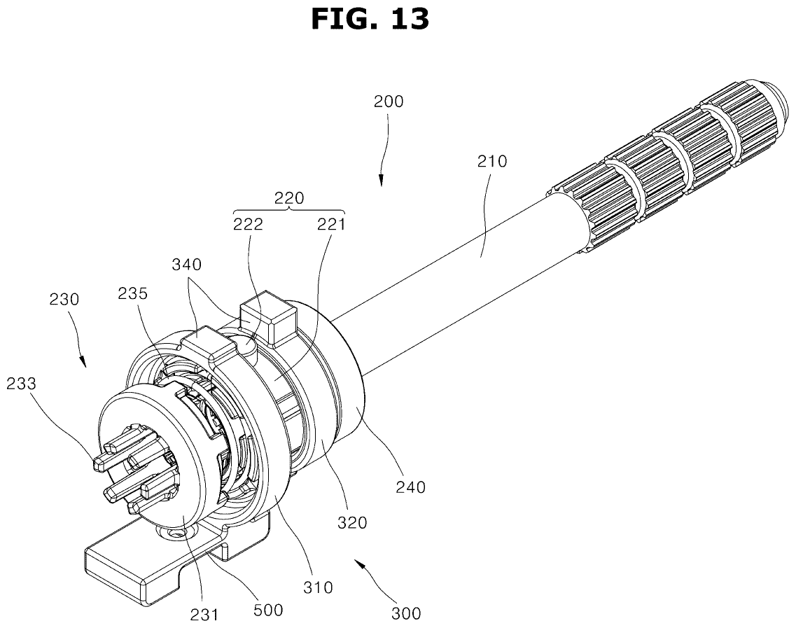

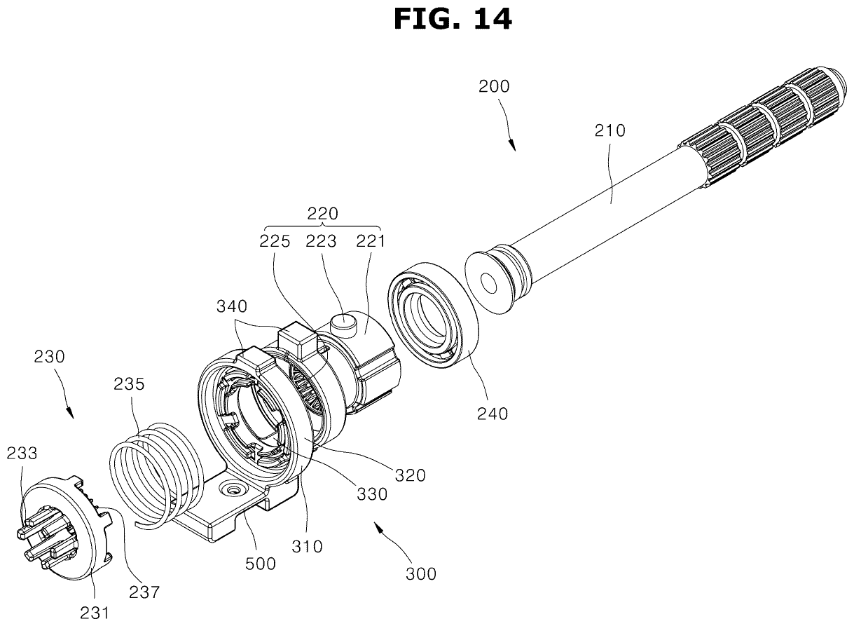

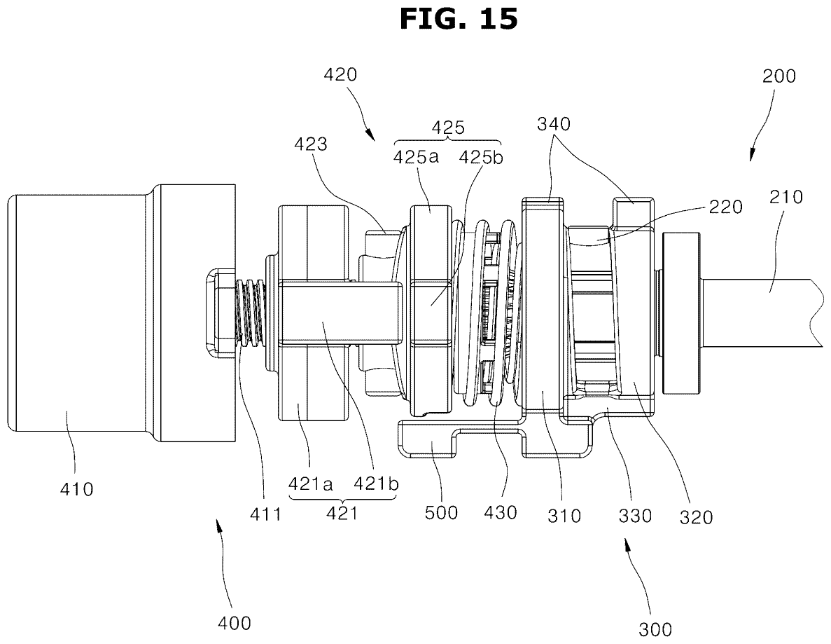

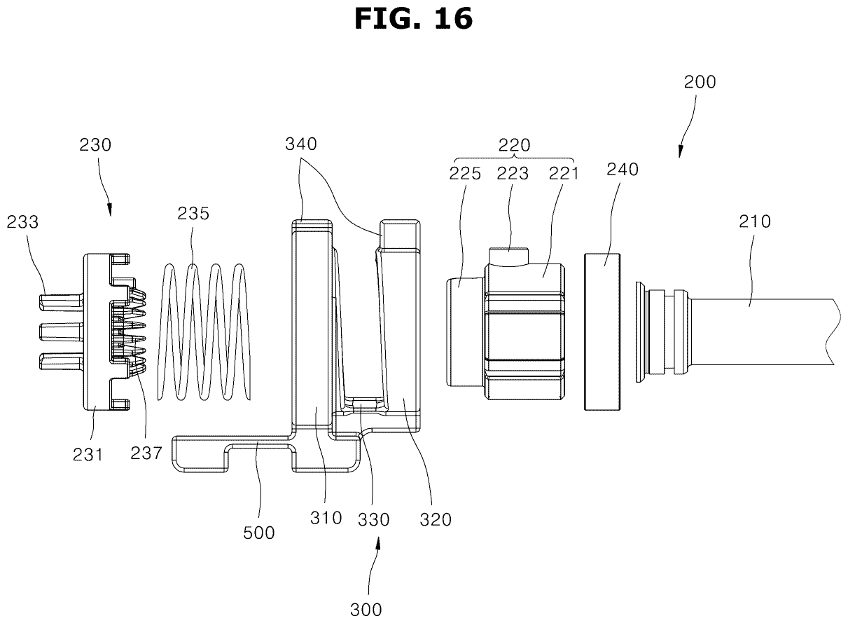

FIG. 1 is a perspective view schematically illustrating an entire steering apparatus for a vehicle according to an embodiment of the present disclosure, FIG. 2 is a perspective view schematically illustrating the steering apparatus for a vehicle according to the embodiment of the present disclosure, FIG. 3 is a perspective view schematically illustrating a main configuration of the steering apparatus for a vehicle according to the embodiment of the present disclosure when viewed in one direction, FIG. 4 is an assembled perspective view schematically illustrating the steering apparatus for a vehicle according to the embodiment of the present disclosure, FIG. 5 is a front view schematically illustrating the main configuration of the steering apparatus for a vehicle according to the embodiment of the present disclosure, FIG. 6 is a perspective view schematically illustrating the main configuration of the steering apparatus for a vehicle according to the embodiment of the present disclosure when viewed in the other direction, FIG. 7 is a perspective view schematically illustrating a normal operation mode of the vehicle in the main configuration of the steering apparatus for a vehicle according to the embodiment of the present disclosure, FIG. 8 is a front view schematically illustrating the normal operation mode of the vehicle in the main configuration of the steering apparatus for a vehicle according to the embodiment of the present disclosure, FIG. 9 is a perspective view schematically illustrating a low-speed operation mode of the vehicle in the main configuration of the steering apparatus for a vehicle according to the embodiment of the present disclosure, FIG. 10 is a front view schematically illustrating the low-speed operation mode of the vehicle in the main configuration of the steering apparatus for a vehicle according to the embodiment of the present disclosure, FIG. 11 is a perspective view schematically illustrating a high-speed operation mode of the vehicle in the main configuration of the steering apparatus for a vehicle according to the embodiment of the present disclosure, FIG. 12 is a front view schematically illustrating the high-speed operation mode of the vehicle in the main configuration of the steering apparatus for a vehicle according to the embodiment of the present disclosure, FIG. 13 is a perspective view schematically illustrating an input shaft part of the steering apparatus for a vehicle according to the embodiment of the present disclosure, FIG. 14 is an assembled perspective view schematically illustrating the input shaft part of the steering apparatus for a vehicle according to the embodiment of the present disclosure, FIG. 15 is an assembled front view schematically illustrating the input shaft part of the steering apparatus for a vehicle according to the embodiment of the present disclosure, and FIG. 16 is an exploded front view schematically illustrating the input shaft part of the steering apparatus for a vehicle according to the embodiment of the present disclosure. For convenience of description, FIGS. 7 to 12 do not illustrate a screw nut body part 421. A detailed structure of the screw nut body part 421 may be identified from FIGS. 3, 4, 6, and the like.

With reference to FIGS. 1 to 16, a steering apparatus for a vehicle according to an embodiment of the present disclosure may include a housing 100, an input shaft part 200, a conversion guide part 300, and a reaction force part 400.

The input shaft part 200, the conversion guide part 300, the reaction force part 400, and the like may be accommodated or mounted in the housing 100.

The input shaft part 200 may be rotatably mounted in the housing 100. The input shaft part 200 may be connected to a steering wheel (not illustrated) and rotate when a driver manually steers the steering wheel or the steering wheel is automatically steered in an autonomous vehicle.

The input shaft part 200 may include an input shaft 210 and an input protrusion portion 220. The input shaft 210 may be rotatably mounted on a second conversion guide part 320 of the conversion guide part 300.

The input shaft 210 may be formed in a rod shape and connected to the steering wheel. The input shaft 210 may rotate when the driver manually steers the steering wheel or the steering wheel is automatically steered in the autonomous vehicle.

The input protrusion portion 220 may be formed in a ring shape and disposed to surround an outer surface of the input shaft 210. The input protrusion portion 220 may be disposed between a first conversion guide part 310 and the second conversion guide part 320 of the conversion guide part 300.

The input protrusion portion 220 may be rotated and moved along a route P along which the input protrusion portion 220 may move.

The input protrusion portion 220 may rotate in conjunction with the rotation of the input shaft 210. When the input protrusion portion 220 is rotated by the rotation of the input shaft 210, the rotation of the input protrusion portion 220 may be restricted as the input protrusion portion 220 is caught by a conversion rotation restriction part 330. When the rotation of the input protrusion portion 220 is restricted as the input protrusion portion 220 is caught by the conversion rotation restriction part 330, a rotation angle of the input shaft 210 may be restricted. In the present disclosure, the rotation angle of the input shaft 210 may be set to 0 to +150°.

The input protrusion portion 220 may include an input protrusion body portion 221, an input protrusion protruding portion 223, and an input protrusion fastening portion 225. The input protrusion body portion 221 may be formed in a ring shape and mounted on a periphery of the input shaft 210. The input protrusion portion 220 may be movable and rotatable between the first conversion guide part 310 and the second conversion guide part 320 of the conversion guide part 300.

The input protrusion protruding portion 223 may protrude from an outer surface of the input protrusion body portion 221. The input protrusion protruding portion 223 may be disposed between the first conversion guide part 310 and the second conversion guide part 320 and move along the route P along which the input protrusion protruding portion 223 may move between the first conversion guide part 310 and the second conversion guide part 320 while rotating in accordance with the rotation of the input shaft 210.

The input protrusion fastening portion 225 may be integrated with the input protrusion body portion 221. The input protrusion fastening portion 225 may protrude from the input protrusion body portion 221 so as to face an input fastening fixing portion 237 of an input fastening part 230.

The input protrusion fastening portion 225 may be fastened to the input fastening fixing portion 237 of the input fastening part 230. An inner peripheral surface of the input protrusion fastening portion 225 may be formed in a shape corresponding to the shape of the input fastening fixing portion 237.

The input protrusion fastening portion 225 is fastened to the input fastening fixing portion 237 of the input fastening part 230 and transmits power of a motor part 410 to the input shaft 210, such that the input shaft 210 may be rotated by an operation of the motor part 410, and the input shaft 210 may not be rotated when the motor part 410 is stopped.

When the input protrusion fastening portion 225 and the input fastening fixing portion 237 are unfastened, the power of the motor part 410 is not transmitted to the input shaft 210. That is, the disconnection between the input protrusion portion 220 and the input fastening part 230 cuts off power transmission from the motor part 410 to the input shaft 210.

The input shaft part 200 may further include the input fastening part 230. The input fastening part 230 may be mounted at an end (a left end based on FIG. 4) of the input shaft 210 and fastened to a screw nut interposition fastening portion 423c of a screw nut interposition portion 423.

The input fastening part 230 may include an input fastening base portion 231, an input fastening coupling portion 233, and an input fastening elastic portion 235.

The input fastening base portion 231 may be formed in a ring shape. The input fastening base portion 231 may be disposed to be spaced apart from the input protrusion portion 220. The input fastening base portion 231 may be mounted at an end (a left end based on FIG. 14) of the input shaft 210.

The input fastening coupling portion 233 may be provided as a plurality of input fastening coupling portions 233 protruding from one side (a left side based on FIGS. 4 and 14) of the input fastening base portion 231 and fastened to the screw nut interposition fastening portion 423c of the screw nut interposition portion 423. Therefore, rotational power of the motor part 410 may be transmitted to the input protrusion portion 220.

The input fastening coupling portion 233 is fastened to the screw nut interposition fastening portion 423c of the screw nut interposition portion 423 and transmits power of the motor part 410 to the input shaft 210, such that the input shaft 210 may be rotated by the operation of the motor part 410, and the input shaft 210 may not be rotated when the motor part 410 is stopped.

As the input protrusion fastening portion 225 and the input fastening fixing portion 237 are selectively fastened, the power of the motor part 410 may be selectively transmitted to the input shaft 210. When the input protrusion fastening portion 225 and the input fastening fixing portion 237 are fastened in the state in which the input fastening coupling portion 233 and the screw nut interposition fastening portion 423c are fastened, the power of the motor part 410 may be transmitted to the input shaft 210. When the input protrusion fastening portion 225 and the input fastening fixing portion 237 are unfastened in the state in which the input fastening coupling portion 233 and the screw nut interposition fastening portion 423c are fastened, the power of the motor part 410 is not transmitted to the input shaft 210.

The selective fastening between the input protrusion fastening portion 225 and the input fastening fixing portion 237 may be controlled by adjusting the movement amount of the screw nut body part 421 on a motor shaft part 411.

The input fastening clastic portion 235 may be interposed between the input fastening base portion 231 and the input protrusion portion 220 and elastically deformable.

The input fastening elastic portion 235 may be elastically deformed between the input fastening base portion 231 and the input protrusion portion 220 by the movement of the input fastening base portion 231 and the movement of the input protrusion body portion 221 of the input protrusion portion 220. That is, the input fastening clastic portion 235 may be elastically deformed by a change in relative distance between the input fastening base portion 231 and the input protrusion body portion 221. The input fastening elastic portion 235 may be a coil spring.

When the screw nut body part 421 is moved toward the input protrusion body portion 221 by the rotation of the motor part 410, the input fastening clastic portion 235 is compressed and deformed, and the input protrusion fastening portion 225 and the input fastening fixing portion 237 engage with each other. In case that a supply of power to the motor part 410 is cut off, the input fastening elastic portion 235 is restored to an original state, such that the input protrusion fastening portion 225 and the input fastening fixing portion 237 are unfastened.

The input fastening part 230 may further include the input fastening fixing portion 237. The input fastening fixing portion 237 may protrude from the other side (a right side based on FIG. 14) of the input fastening base portion 231 and be coupled to the input protrusion portion 220 while moving.

The input fastening fixing portion 237 may be fastened to the input protrusion fastening portion 225 of the input protrusion portion 220, such that the input shaft 210 may not rotate when the motor part 410 is stopped. In the state in which the input fastening fixing portion 237 and the input protrusion fastening portion 225 are fastened, the operation of the motor part 410 is transmitted to the input shaft 210 in an intact manner. That is, the input shaft 210 also rotates when the motor part 410 rotates, and the input shaft 210 is also stopped when the motor part 410 is stopped.

The conversion guide part 300 may be mounted on the input shaft part 200 and may guide the rotating input shaft part 200 so that the rotating input shaft part 200 rectilinearly moves in the housing 100.

The conversion guide part 300 may include the first conversion guide part 310, the second conversion guide part 320, and the rotation restriction part 330. The first conversion guide part 310 may adjoin an elastic part 430 of the reaction force part 400 and be provided with an elastic force from the elastic part 430. The first conversion guide part 310 may adjoin the elastic part 430 of the reaction force part 400 and be provided with the elastic force of the elastic part 430, which is compressively deformed, such that the first conversion guide part 310 may adjust a reaction force of the input shaft part 200. The first conversion guide part 310 may be formed in a hollow shape.

The second conversion guide part 320 may be disposed to be spaced apart from the first conversion guide part 310, and the input shaft part 200 may be rotatably mounted on the second conversion guide part 320. The second conversion guide part 320 may be formed in a hollow shape so that the input shaft 210 of the input shaft part 200 is mounted on the second conversion guide part 320. An inner diameter of the second conversion guide part 320 is larger than an outer diameter of the input shaft 210 so that the input shaft 210 of the input shaft part 200 may rotate.

The rotation restriction part 330 may connect the first conversion guide part 310 and the second conversion guide part 320 and restrict the rotation angle of the input shaft part 200. The input protrusion portion 220 of the input shaft part 200, which moves along the route P formed between the first conversion guide part 310 and the second conversion guide part 320, is caught by the rotation restriction part 330, such that the rotation angle of the input shaft 210 of the input shaft part 200 may be restricted. The rotation angle of the input shaft 210 of the input shaft part 200 may be set in accordance with a width of the rotation restriction part 330.

The input protrusion portion 220 may simultaneously move and rotate between the first conversion guide part 310 and the second conversion guide part 320. The movement route P of the input protrusion portion 220 between the first conversion guide part 310 and the second conversion guide part 320 may be formed in an oblique direction (see FIG. 5). With reference to FIG. 5, the movement route P of the input protrusion portion 220 may be formed along an oblique line inclined in a leftward/upward direction from a right side toward a left side. Therefore, as an angle by which the input protrusion portion 220 rotates increases, a distance by which the input protrusion portion 220 moves may increase.

In the present disclosure, the conversion guide part 300 may further include conversion protruding portions 340. The conversion protruding portions 340 may respectively protrude from the first conversion guide part 310 and the second conversion guide part 320 and be inserted into an inner surface of the housing 100. The conversion protruding portion 340 may be inserted and mounted into the inner surface of the housing 100 and prevent the first conversion guide part 310 and the second conversion guide part 320 from rotating. The rotations of the first and second conversion guide parts 310 and 320 are prevented, such that the first and second conversion guide parts 310 and 320 may be fixed to the position of the rotation restriction part 330 that restricts the rotation angle of the input shaft part 200.

The reaction force part 400 may adjust a steering reaction force of the input shaft part 200 while providing the elastic force to the input shaft part 200. The reaction force part 400 may adjust the steering reaction force of the input shaft part 200 by adjusting the elastic force to be provided to the input shaft part 200 in accordance with a velocity of the vehicle.

The reaction force part 400 may include the motor part 410, a screw nut part 420, and the clastic part 430. The motor part 410 may have a motor shaft part 411 and rotate the motor shaft part 411. In the present disclosure, the motor part 410 may serve to adjust the compressive deformation of the elastic part 430 by operating the screw nut part 420 connected to the motor shaft part 411. A motor having a smaller capacity than a motor in the related art may be used as the motor part 410.

A screw thread may be formed on an outer surface of the motor shaft part 411, such that the motor shaft part 411 may be screw-fastened to the screw nut part 420.

The screw nut part 420 may be connected to the motor shaft part 411 of the motor part 410 and moved by the rotation of the motor shaft part 411. The screw nut part 420 may include a screw nut body part 421, a screw nut protrusion part 423, and a screw nut pressing part 425.

The screw nut body part 421 may be screw-fastened to the motor shaft part 411 and moved by the rotation of the motor shaft part 411. The screw nut body part 421 may include a screw nut body movement portion 421a and screw nut rotation restriction portions 421b.

The screw nut body movement portion 421a may be screw-fastened to the motor shaft part 411. The screw nut body movement portion 421a may have a screw thread formed on an inner surface thereof and screw-fastened to the motor shaft part 411.

The screw nut rotation restriction portion 421b may protrude from a lateral surface of the screw nut body movement portion 421a and adjoin an inner side of the housing 100, thereby restricting the rotation of the screw nut body movement portion 421a. The screw nut rotation restriction portion 421b may adjoin the inner side of the housing 100, such that the screw nut body movement portion 421a, which is rotated by the rotation of the motor shaft part 411, may move rectilinearly and translationally in the housing 100.

At least one of the screw nut rotation restriction portions 421b may protrude from a lateral surface of the screw nut body movement portion 421a toward the screw nut pressing part 425. The screw nut rotation restriction portions 421b may protrude from two opposite surfaces of the screw nut body movement portion 421a.

The screw nut interposition portion 423 may include a screw nut interposition body portion 423a and a screw nut interposition protrusion portion 423b. The screw nut interposition body portion 423a may be mounted on the motor shaft part 411 and interposed between the screw nut body part 421 and the screw nut pressing part 425.

The screw nut interposition portion 423 may be rotated at the same rotation angle as the motor shaft part 411 by the rotation of the motor shaft part 411. The screw nut interposition portion 423 may rotate in place on the motor shaft part 411 without reciprocating between the motor part 410 and the screw nut pressing part 425.

The screw nut interposition protrusion portion 423b may protrude from the screw nut interposition body portion 423a and move along a screw nut crest/trough portion 425c while rotating in place on the motor shaft part 411. As the screw nut interposition protrusion portion 423b moves along the screw nut crest/trough portion 425c, the amount by which the screw nut pressing part 425 compresses the elastic part 430 may be adjusted.

The screw nut pressing part 425 may press the elastic part 430 while being moved by the movement of the screw nut body part 421.

The screw nut pressing part 425 may include a screw nut pressing movement portion 425a and screw nut pressing rotation restriction portions 425b. A central portion of the screw nut pressing movement portion 425a may be formed in a hollow shape into which the motor shaft part 411 is inserted.

The screw nut rotation restriction portion 425b may protrude from a lateral surface of the screw nut pressing movement portion 425a and adjoin an inner side of the housing 100, thereby restricting the rotation of the screw nut pressing movement portion 425a.

The screw nut rotation restriction portion 425b may adjoin the inner side of the housing 100, such that the screw nut pressing movement portion 425a may move rectilinearly and translationally in the housing 100.

At least one of the screw nut pressing rotation restriction portions 425b may protrude from the lateral surface of the screw nut pressing movement portion 425a. The screw nut pressing rotation restriction portions 425b may protrude from two opposite surfaces of the screw nut pressing movement portion 425a.

The screw nut rotation restriction portion 425b may be moved toward the elastic part 430 by the movement of the screw nut rotation restriction portion 421b. The pressing of the elastic part 430 by the screw nut rotation restriction portion 425b may be adjusted by the screw nut rotation restriction portion 421b and/or the screw nut interposition protrusion portion 423b.

The screw nut pressing part 425 may further include the screw nut crest/trough portion 425c. The screw nut crest/trough portion 425c may have crests and troughs formed on a surface, opposite to the screw nut interposition protrusion portion 423b, of the screw nut pressing movement portion 425a.

With reference to FIGS. 7, 9, and 11, the screw nut crest/trough portion 425c has the crest formed in the horizontal direction of the screw nut pressing movement portion 425a, and the trough in an upward/downward direction. The amount by which the clastic part 430 is pressed may be adjusted as the screw nut interposition protrusion portion 423b moves along and adjoins the crest and the trough of the screw nut crest/trough portion 425c.

That is, the amount by which the clastic part 430 is pressed increases (see FIG. 11) when the screw nut interposition protrusion portion 423b, which rotates in place, adjoins the crest of the screw nut crest/trough portion 425c, and the amount by which the elastic part 430 is pressed relatively decreases (see FIG. 7) when the screw nut interposition protrusion portion 423b adjoins the trough of the screw nut crest/trough portion 425c.

FIGS. 7 and 8 illustrate a normal operation mode of the vehicle, and the screw nut interposition protrusion portion 423b may be disposed on the screw nut crest/trough portion 425c in a state in which the screw nut interposition protrusion portion 423b is inclined at an about 45 degrees. That is, the screw nut interposition protrusion portion 423b may be disposed at an intermediate point between the crest and the trough of the screw nut crest/trough portion 425c.

The screw nut interposition protrusion portion 423b may be rotatable on the screw nut crest/trough portion 425c. The rotation of the screw nut interposition protrusion portion 423b may cause the screw nut pressing part 425 to move to pressurize the clastic part 430, and the pressurized elastic part 430 may be compressed.

FIGS. 9 and 10 illustrate a low-speed operation mode of the vehicle, and the screw nut interposition protrusion portion 423b may be disposed on the trough of the screw nut crest/trough portion 425c in a state in which the screw nut interposition protrusion portion 423b is inclined at 0 degree (an upward/downward arrangement state). Therefore, the compressive deformation of the elastic part 430 in the low-speed operation mode of the vehicle is smaller than the compressive deformation of the elastic part 430 in the normal operation mode of the vehicle.

In the low-speed operation mode of the vehicle, the amount of compressive deformation of the elastic part 430 may be decreased to decrease the reaction force of the input shaft part 200 and make the adjustment of the steering wheel light.

FIGS. 11 and 12 illustrate a high-speed operation mode of the vehicle, and the screw nut interposition protrusion portion 423b may be disposed on the crest of the screw nut crest/trough portion 425c in a state in which the screw nut interposition protrusion portion 423b is inclined at 90 degrees (a leftward/rightward arrangement state). Therefore, the compressive deformation of the elastic part 430 in the high-speed operation mode of the vehicle is greater than the compressive deformation of the elastic part 430 in the normal operation mode of the vehicle.

In the high-speed operation mode of the vehicle, the amount of compressive deformation of the elastic part 430 may be increased to increase the reaction force of the input shaft part 200 and make the adjustment of the steering wheel heavy.

When the screw nut interposition protrusion portion 423b moves the screw nut pressing part 425 so that the elastic part 430 is compressed to the maximum, the input protrusion fastening portion 225 may be fastened with the input fastening fixing portion 237 of the input fastening part 230. Since the power of the motor part 410 is transmitted to the input shaft 210, the input shaft 210 may be rotated by the operation of the motor part 410, or the input shaft 210 may be prevented from rotating when the motor part 410 is stopped. Accordingly, the steering wheel cannot rotate and can be fixed.

The elastic part 430 may be interposed between the screw nut part 420 and an end of the input shaft part 200, specifically, the input protrusion portion 220, and elastically deformed by the movement of the screw nut part 420. The elastic part 430 may be configured as a coil spring.

The steering apparatus for a vehicle according to the present disclosure may further include a sensor part 500. The sensor part 500 may measure a rotation angle of the input shaft part 200. In the present disclosure, the sensor part 500 may be configured as a torque and angle sensor (TAS) or a linear sensor. Structures and operations of the TAS and the linear sensor may depend on the structures and operations of the general TAS and the general linear sensor.

The sensor part 500 may be configured as a torque and angle sensor (TAS) configured to measure torque of the input shaft 210 and measure a rotation angle of the input protrusion portion 220. The TAS of the sensor part 500 may measure a steering state of the steering wheel by measuring both the torque of the input shaft 210 and the rotation angle of the input protrusion portion 220.

The sensor part 500 may be configured as a linear sensor configured to measure a position of the input protrusion portion 220. The movement route P of the input protrusion portion 220 may be formed in an oblique direction, such that the linear sensor of the sensor part 500 may measure the positional deformation of the input protrusion portion 220.

The amount in which the screw nut pressing part 425 compressively deforms the elastic part 430 may be adjusted in accordance with the operation of the motor part 410 of the reaction force part 400.

According to the steering apparatus for a vehicle according to the present disclosure, the driver may steer the vehicle while sufficiently feeling the steering reaction force by means of the compressive elastic force of the elastic part even without a speed reducer.

In addition, according to the present disclosure, it is possible to control the reaction force by adjusting the compression length of the elastic part in accordance with the velocity of the vehicle by using the small-scale motor part and the screw nut part.

In addition, according to the present disclosure, it is not necessary to use a basic speed reducer and a large motor, and the constituent components may be simplified by the elastic part and the small-scale motor part, such that manufacturing costs may be reduced, and the productivity may be improved.

While the specific embodiments of the present disclosure have been described above, the spirit and scope of the present disclosure are not limited to the specific embodiments, and may be variously modified and changed by those skilled in the art to which the present disclosure pertains without departing from the subject matter of the present disclosure disclosed in the claims.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A steering apparatus for a vehicle, comprising:
a housing;
an input shaft part rotatably mounted in the housing;
a conversion guide part mounted on the input shaft part and configured to guide the input shaft part to move rectilinearly in the housing; and
a reaction force part configured to adjust a steering reaction force of the input shaft part while providing an elastic force to the input shaft part.

2. The steering apparatus of claim 1, wherein the reaction force part comprises:
a motor part including a motor shaft part;
a screw nut part connected to the motor shaft part and configured to be moved by a rotation of the motor shaft part; and
an elastic part interposed between the screw nut part and the input shaft part and configured to be elastically deformed by movements of the screw nut part and the input shaft part.

3. The steering apparatus of claim 2, wherein the screw nut part comprises:
a screw nut body part screw-fastened to the motor shaft part and configured to move in accordance with the rotation of the motor shaft part;
a screw nut pressing part configured to press the elastic part while moving in accordance with a movement of the screw nut body part; and
a screw nut interposition portion mounted on the motor shaft part and disposed between the screw nut body part and the screw nut pressing part.

4. The steering apparatus of claim 3, wherein the screw nut body part comprises:
a screw nut body movement portion screw-fastened to the motor shaft part; and
a screw nut rotation restriction portion protruding externally of the screw nut body movement portion and configured to adjoin an inner side of the housing to restrict a rotation of the screw nut body movement portion.

5. The steering apparatus of claim 4, wherein the screw nut pressing part comprises:
a screw nut pressing movement portion having a central portion into which the motor shaft part is inserted; and
a screw nut pressing rotation restriction portion protruding externally of the screw nut pressing movement portion and configured to adjoin the inner side of the housing to restrict a rotation of the screw nut pressing movement portion.

6. The steering apparatus of claim 5, wherein the screw nut pressing rotation restriction portion is configured to move toward the elastic part when pressed by the screw nut rotation restriction portion.

7. The steering apparatus of claim 5, wherein the screw nut pressing part further comprises a screw nut crest/trough portion having a crest and a trough formed on a surface of the screw nut pressing movement portion opposite to the screw nut interposition portion.

8. The steering apparatus of claim 7, wherein the screw nut interposition portion comprises:
a screw nut interposition body portion mounted on the motor shaft part and interposed between the screw nut body part and the screw nut pressing part; and
a screw nut interposition protrusion portion protruding from the screw nut interposition body portion and configured to be rotatable in a state in which the screw nut interposition protrusion portion adjoins the screw nut crest/trough portion.

9. The steering apparatus of claim 8, wherein the screw nut interposition portion comprises:
a plurality of screw nut interposition portions protruding from the screw nut interposition body portion toward the input shaft part; and
a screw nut interposition fastening portion fastened to the input shaft part.

10. The steering apparatus of claim 9, wherein the conversion guide part comprises:
a first conversion guide part adjoining the elastic part and receive an elastic force from the elastic part;
a second conversion guide part spaced apart from the first conversion guide part and configured to allow the input shaft part to be rotatably mounted on the second conversion guide part; and
a conversion rotation restriction part configured to connect the first conversion guide part and the second conversion guide part and restrict a rotation angle of the input shaft part.

11. The steering apparatus of claim 10, wherein the conversion guide part further comprises a plurality of conversion protruding portions respectively protruding from the first conversion guide part and the second conversion guide part and inserted into an inner surface of the housing.

12. The steering apparatus of claim 10, wherein the input shaft part comprises:
an input shaft rotatably mounted on the second conversion guide part; and
an input protrusion portion protruding from an outer surface of the input shaft and configured to move between the first conversion guide part and the second conversion guide part, the input protrusion portion being configured to be caught by the conversion rotation restriction part so that a movement of the input protrusion portion is restricted.

13. The steering apparatus of claim 12, wherein the input shaft part further comprises an input fastening part mounted at an end of the input shaft and fastened to the screw nut interposition fastening portion.

14. The steering apparatus of claim 13, wherein the input fastening part comprises:
an input fastening base portion spaced apart from the input protrusion portion;
a plurality of input fastening coupling portions protruding from a first side of the input fastening base portion and fastened to the screw nut interposition fastening portion; and
an input fastening elastic portion interposed between the input fastening base portion and the input protrusion portion and configured to be elastically deformable.

15. The steering apparatus of claim 14, wherein the input fastening part further comprises an input fastening fixing portion protruding from a second side of the input fastening base portion and configured to be selectively coupled to the input protrusion portion while moving.

16. The steering apparatus of claim 12, further comprising a sensor part configured to measure a rotation angle of the input shaft part.

17. The steering apparatus of claim 16, wherein the sensor part comprises a torque and angle sensor (TAS) configured to measure an amount of torque of the input shaft and a rotation angle of the input protrusion portion.

18. The steering apparatus of claim 16, wherein the sensor part comprises a linear sensor configured to measure a position of the input protrusion portion.
